(19) United States
(12) Patent Application Publication
(10) Pub. No.: US 2003/0100959 A1
(43) Pub. Date: May 29, 2003

(54) Computer temperature control system

(76) Inventor: Hung Tsi Liu, Tao Yuan Hsien (TW)

Correspondence Address: BACON & THOMAS, PLLC, 625 SLATERS LANE, FOURTH FLOOR, ALEXANDRIA, VA, 22314

(21) Appl. No.: 09/994,879

(22) Filed: Nov. 28, 2001

(51) Int. Cl. G05B 11/01; G05B 9/02

(52) U.S. Cl. 700/21; 700/27; 700/79

(57) ABSTRACT

A computer temperature control system installed in a host computer and adapted for controlling the inside temperature of the host computer, the system including cooling fans mounted in the host computer at different locations, a MPU, temperature sensors adapted for detecting the ambient temperature around each cooling fan, an analog-to-digital converter adapted for converting analog temperature signal from each temperature sensor into a corresponding digital temperature signal for comparison with the corresponding pre-set temperature level for enabling the main processing unit to control the revolving speed of the respective cooling fan subject to the respective comparison result.

### BACKGROUND OF THE INVENTION

The present invention relates to a computer temperature control system and, more particularly, to such a computer temperature control system, which automatically controls the revolving speeds of different fans at different locations inside the host computer subject to the actual ambient temperature at predetermined locations inside the host computer, keeping the inside temperature of the host computer within the desired set level.

During running of the CPU of a computer, much heat is produced. Various CPU cooling apparatus have been disclosed for dissipating heat from the CPU of a computer. Regular CPU cooling apparatus are commonly comprised of a heat sink and a cooling fan. The CPU receives heat from the CPU. The cooling fan blows air through the heat sink to carry heat away from the heat sink and the CPU. Because air is circulating in the computer without causing convection, the heat dissipation efficiency is low. In order to eliminate this problem, additional exhaust fan means may be provided. However, regular fans for computer have only one fixed revolving speed, i.e., the revolving speed of cooling fans cannot be adjusted automatically subject to the ambient temperature level.

### SUMMARY OF THE INVENTION

The present invention has been accomplished to provide a computer temperature control system, which automatically controls the revolving speeds of different fans at different locations in the host computer subject to the respective ambient temperature levels. According to one aspect of the present invention, the computer temperature control system comprises multiple cooling fans mounted in the host computer at different locations, a MPU, temperature sensors adapted for detecting the ambient temperature around each cooling fan, an analog-to-digital converter adapted for converting analog temperature signal from each temperature sensor into a corresponding digital temperature signal for comparison with the corresponding pre-set temperature level for enabling the main processing unit to control the revolving speed of the respective cooling fan subject to the respective comparison result. According to another aspect of the present invention, a control panel is provided at the front side of the host computer for data entry. According to still another aspect of the present invention, the control panel comprises a LCD for data output from the MPU.

### BRIEF DESCRIPTION OF THE DRAWINGS

FIG. 1 is an exploded view of the present invention.

FIG. 2 is a system block diagram of the present invention.

### DETAILED DESCRIPTION OF THE PREFERRED EMBODIMENT

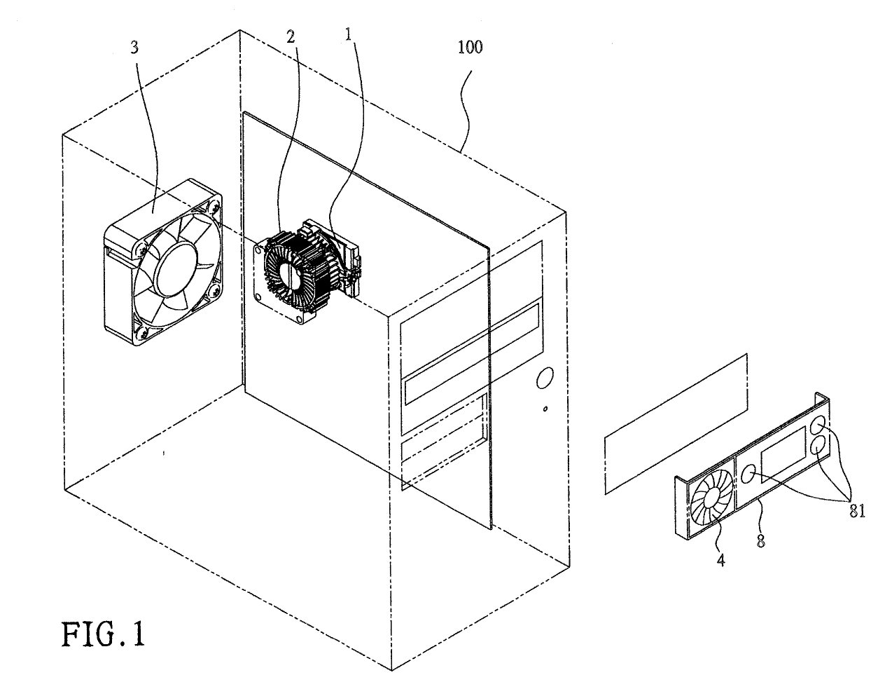

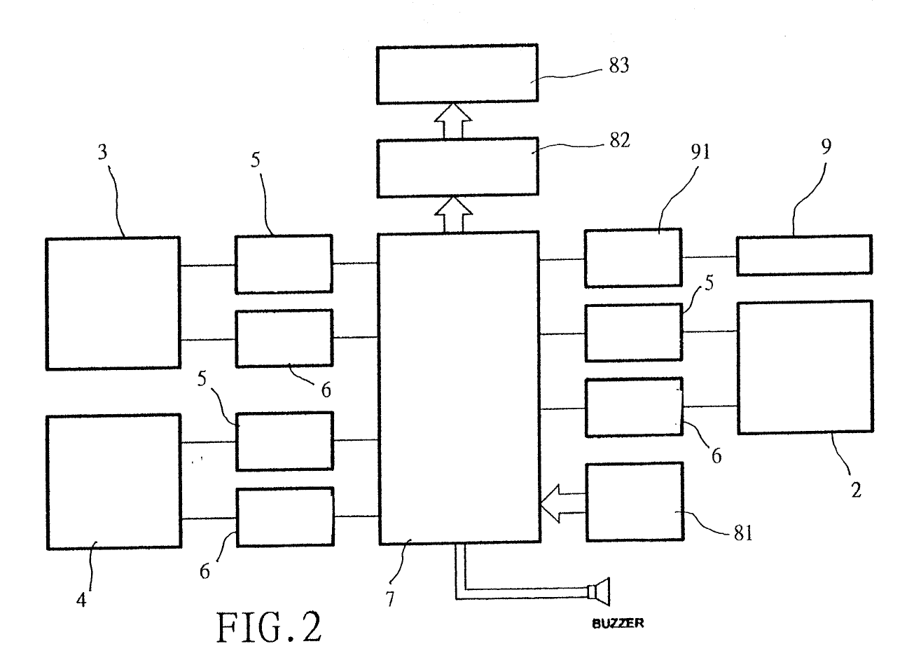

Referring to FIGS. 1 and 2, a computer temperature control system in accordance with the present invention is shown comprising a first fan 2 mounted on a heat sink (not shown) at the CPU 1 of the host computer 100, a second fan provided at the rear side of the host computer 100, a third fan provided at the front side of the host computer 100, a fan speed detecting loop 5 adapted for detecting the revolving speed of the fans 1;2;3, a fan speed controlling loop 6 adapted for controlling the revolving speed of the fans 1;2;3, a MPU (main processing unit) 7 adapted for controlling the operation of the operations of the fan speed detecting loop 5 and the fan speed controlling loop 6, a control panel 8 mounted on the front sidewall of the host computer 100 and connected to the MPU 7 for data input/output, an analog-to-digital converter 91, and temperature sensors 9 respectively mounted on the CPU 1 and locations near the front and rear sides in the host computer 100 and respectively connected to the analog-to-digital converter 91 and then the MPU 7. The control panel 8 comprises a set of data-entry buttons 81 for data input into the MPU 7, a LCD 83 for data output, and a LCD driver 82 for driving the LCD 83 to output data.

Through the data-entry buttons 81 of the control panel 8, the user inputs predetermined parameters into the MPU 7. These parameters include predetermined temperature values, fan revolving speed values (for example, high, medium, low revolving speeds). When the host computer 100 started, the temperature sensors 9 ceaselessly detect the temperature of the CPU 1 and the internal temperature of the host computer 100. The analog-to-digital converter 91 converts detected analog temperature signal from each temperature sensor 9 into corresponding digital temperature signal for comparison with the respective pre-set temperature value at the MPU 7. When the detected temperature value from one temperature sensor 9 surpasses or drops below the corresponding pre-set temperature value, the MPU 9 immediately drives the fan speed controlling loop 6 to regulate the revolving speed of the corresponding fan 1, 2, or 3.

A prototype of computer temperature control system has been constructed with the features of FIGS. 1 and 2. The computer temperature control system functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A computer temperature control system installed in a host computer and adapted for controlling the inside temperature of said host computer, comprising:
a plurality of cooling fans mounted inside said host computer;
a main processing unit mounted in said host computer and adapted for setting the desired temperature level and controlling the revolving speed of said cooling fans subject to the set temperature level;
a fan speed control loop connected betweens aid main processing unit and said cooling fan and driven by said main processing unit to control the revolving speed of said cooling fans;
a plurality of temperature sensors respectively mounted inside said host computer adjacent to said cooling fans and adapted for detecting the ambient temperature around said cooling fans respectively;
an analog-to-digital converter connected between said temperature sensors and said main processing unit and adapted for converting analog temperature signal from each of said temperature sensors into a corresponding digital temperature signal and outputting the corresponding digital temperature signal to said main processing unit for comparison with the corresponding pre-set temperature level for enabling said main processing unit to control the revolving speed of the respective cooling fan subject to the respective comparison result.

2. The computer temperature control system as claimed in claim 1 further comprising a control panel mounted on a front sidewall of said host computer, said control panel comprising a set of data0entry buttons respectively connected to said main processing unit for data input.

3. The computer temperature control system as claimed in claim 2, wherein said control panel comprises a liquid crystal display for data output from said main processing unit.
